(19) United States
(12) Patent Application Publication
(10) Pub. No.: US 2007/0058142 A1
(43) Pub. Date: Mar. 15, 2007

(54) Display system

(76) Inventors: George Radominski, Corvallis, OR (US); Timothy R. Emery, Corvallis, OR (US); Steve P. Hanson, Albany, OR (US); Alexander Govyadinov, Corvallis, OR (US); Robert W. Shreeve, Moscow, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/223,381

(22) Filed: Sep. 9, 2005

(51) Int. Cl. G03B 21/28

(52) U.S. Cl. 353/99

(57) ABSTRACT

One embodiment of a display system includes an array that defines multiple reflective devices, a first subset of said devices each movable into a position to reflect light to an imaging region and a second subset of said devices each positioned to reflect light to a sensing region, and a light source that projects a light beam to the array, wherein light reflected by the first subset is incident on the imaging region and wherein light reflected by the second subset is incident on the sensing region.

### BACKGROUND

Display systems, such as projection type devices, may include one or more optical modulators. The modulators may each include a plurality of reflective devices, such as movable micromirrors, wherein each micromirror corresponds to a pixel or a sub-pixel of the modulator. A display system may function by reflecting light from pixels or sub-pixels of the one or more modulators in accordance with the individual positions of the pixels or sub-pixels.

### BRIEF DESCRIPTION OF THE DRAWINGS

FIG. 1 is a schematic cross-sectional side view of one embodiment of a display system including a micromirror array including one embodiment of a sensing device.

FIG. 2 is a schematic cross-sectional side view of one embodiment of a display system including several micromirror arrays and several activation devices.

### DETAILED DESCRIPTION OF THE DRAWINGS

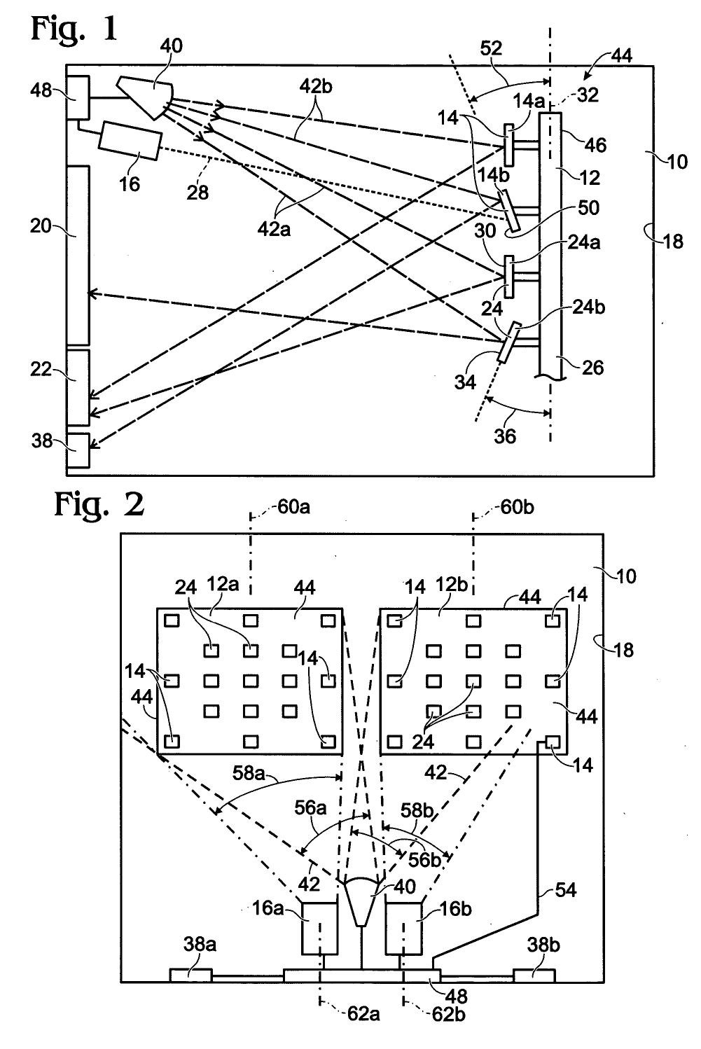

FIG. 1 is a schematic cross-sectional side view of one embodiment of a display system 10 including a micromirror array 12, including one embodiment of a sensing device 14, and an activation device 16 housed within a housing 18. Display system 10 may be a television, a camera, a digital projector, a monitor, an electronic device display screen, or the like. Display system 10 may further comprise a viewing region 20 and a light dump 22. Array 12 may include an exemplary set of movable mirrors 24, such as micromirrors, movably mounted on a support base 26, along with sensing devices 14. Mirrors 24 may be adapted to move between a first or “off” position 24a and a second or “on” position 24b. In the embodiment shown, two micromirrors 24 and two sensing devices 14, such as mirrors, are shown for ease of illustration. However, in other embodiments, an array of hundreds, thousands, or more, of movable mirrors 24 and/or sensing devices 14 may be mounted on base 26 of display system 10. While system 10 in the illustrated embodiment is an optical device, it will be understood by those skilled in the art that the invention is not limited to optical devices.

Support base 26 may be manufactured from any suitable material, and in the embodiment shown, may be manufactured from a silicon based material, such as glass. Mirrors 24 may be manufactured from any reflective material, and in one exemplary embodiment, may be manufactured from an aluminum coating formed on a movable, rigid plate, such as by deposition techniques. Sensing devices 14 may also be a micromirror device, such as an aluminum coating formed on a rigid plate by deposition techniques. In the embodiment shown, sensing devices 14 are movably mounted on base 26.

Activation device 16 may be an electron beam generator that may generate an electron beam 28 directed toward support base 26 having mirrors 24 and sensing devices 14 mounted thereon. Housing 18 may define a vacuum therein such that electron beam generator 16, electron beam 28, sensing devices 14 and movable mirrors 24 are all housed within a vacuum. In one embodiment, electron beam generator 16 may sweep beam 28 sequentially across each of mirrors 24a and 24b and sensing devices 14a and 14b to control the position of the mirrors, such as controllably moving the imaging mirrors 24 between first or inactive position 24a and second or active position 24b. In first position 24a, an imaging mirror may be positioned with its front reflective surface 30 positioned parallel to a plane 32. In second position 24b, a mirror may be positioned with its front reflective surface 34 positioned at an angle 36 with respect to plane 32, wherein angle 36 may be in a range of −90 to +90 degrees. In other embodiments, the “off” position of mirrors 24 may be angled and the on position may be parallel with respect to plane 32, or both the on and the off positions may be angled with respect to plane 32.

Similarly, in the embodiment wherein sensing devices 14 are movable mirrors, electron beam generator 16 may sweep beam 28 sequentially across each of sensing devices 14 to controllably move ones of the sensing device mirrors between a sensing position 14b wherein light is reflected from the sensing device mirror 14b to a sensor 38 and a non-sensing position 14a wherein light is reflected from sensing device mirror 14a to light dump 22. In sensing position 14b, a mirror may be positioned with its front reflective surface 50 positioned at an angle 52 with respect to plane 32, wherein angle 52 may be in a range of −90 to 90 degrees, as measured in an opposite direction from the measurement of angle 36 of mirror 24b for example. In other words, sensing devices 14 may be mounted on one or more supports that tilt sensing devices 14 in a direction different from imaging mirrors 24. In other embodiments, the nonsensing position of sensing devices 14 may be angled and the sensing position may be parallel with respect to plane 32, or both the sensing and the nonsensing positions may be angled with respect to plane 32. In some embodiments, the sensing devices may be tilted in the same direction as the imaging mirrors but at a different angle. For example, in such an embodiment the imaging mirrors may be tilted at +45 degrees and the sensing device mirrors may be tilted at +60 degrees, for example. Accordingly, even though sensing device 14 and imaging mirrors 24 may tilt in different directions with respect to base 26, sensing device 14 and imaging mirrors 24 may be manufactured in the same manner as one another on base 26.

Sensing devices 14 may be placed throughout array 12 at strategic locations such that sensing devices 14 are interspersed with movable imaging mirrors 24. Accordingly, activation device 16 may sweep electron beam 28 over the entire array to activate both movable mirrors 24 and sensing devices 14 in the same sweeping action of beam 28.

Display device 10 may further include a light source 40 that produces a light beam 42 directed toward sensing devices 14 and movable mirrors 24 mounted on support base 26. Light source 40 may generate light beam 42 having a wavelength in a range of 380 nm to 780 nm. However, any suitable type of light may be generated by an appropriate light source as may be utilized for a particular application. Moreover, in one embodiment, light source 40 may produce a first beam of light 42a, having a first wavelength and being directed toward imaging mirrors 24, and a second beam of light 42b, having a second wavelength and being directed toward sensing devices 14. In still another embodiment, light source 40 may include two separate light generation devices that may each produce a light beam 42a and 42b, respectively, having a unique wavelength. The use of two different wavelengths of light may allow a visible light to be reflected by imaging mirrors 24 to imaging region 20 and invisible light to be reflected by sensing device 14 to sensor 38 such that the two wavelengths of light do not interfere with one another during simultaneous operation of imaging region 20 and sensor 38.

In operation of one exemplary embodiment, display device 10 may function as follows. Electron beam generator 16 scans array 12 with beam 28 to activate individual ones of movable mirrors 24 to the on/activated state 24b and other individual ones of movable mirrors 24 to the off/unactivated state 24a, such that the activated mirrors 24b may be angled at angle 36 with respect to plane 32, and such that the unactivated mirrors 24a may be positioned parallel to plane 32. Light beam 42a may be directed toward micromirror array 12. A portion of light beam 42a that is directed toward activated mirrors 24b will be reflected by mirrors 24b toward imaging region 20 and a portion of light beam 42a that is directed toward unactivated mirrors 24a will be reflected by mirrors 24a toward light dump 22. The light received by imaging region 20 may form an image thereon that may be projected to or viewed directly by a viewer (not shown). The process may then be repeated again and again with different individual ones of micromirrors 24 being activated and/or deactivated such that different images are sequentially formed on imaging region 20 to produce a desired single or motion, color or black and white, picture image. During this repetitive process, undesirable light reflected by unactivated mirrors 24a may be reflected to light dump 22 such that the undesirable light is not reflected to imaging region 20 and is not viewed by a viewer.

During, before or after forming images on imaging on region 20 from mirrors 24, light 42b may be projected from light source 40 to sensing devices 14. In one embodiment, sensing devices 14 may be immovably positioned in a sensing position wherein light 42b may be reflected from one or more of sensing devices 14 to sensor 38. The light received by sensor 38 from one or more sensing devices 14 may be utilized to align the position of light source 40 with respect to array 12. In particular, sensing devices 14 may be strategically positioned on array 12, such as in an edge region 44 of array 12, and more particularly, at each of the four corners 46 (only one corner is shown for ease of illustration in FIG. 1) of array 12. When light 42b is projected to array 12, devices 14 that receive light 42b will reflect the light to sensor 38. Sensor 38 may indicate to a controller 48 of system 10 that light is detected at sensor 38 from one or more of sensing devices 14. The light detection information received by controller 48 from one or more sensors 38 may then be utilized to move or position light source 40 so that it is correctly aligned and sized with respect to array 12. In other words, if light source 40 is misaligned with respect to, or defines a light beam smaller than, array 12, some of sensing devices 14 may not be illuminated and may not reflect light to sensor 38. Controller 48 may determine which of devices 14 are not receiving light based on information received from sensor 38, whereafter controller 48 may use this information to correct the position and/or size of light beam 42 such that the entirety of array 12 is illuminated, including each corner 46 and all of edge regions 44 of array 12.

Still referring to FIG. 1, in another embodiment sensing devices 14 may be movably positioned between a sensing position 14b wherein light 42b may be reflected from one or more of sensing devices 14 to sensor 38 and a nonsensing position 14a wherein light 42b reflected to sensing device 14 is projected by device 14a to light dump 22. The light received by sensor 38 from one or more of devices 14b may be utilized to align the position of, or to define the size or pattern of, electron beam 28 of activation device 16 with respect to array 12. In particular, sensing devices 14 may be strategically positioned on array 12, such as in an edge region 44 of array 12, and more particularly, at each of the four corners 46 (only one corner is shown for ease of illustration in FIG. 1) of array 12. When particular sensing devices 14a are not activated by beam 28 of activation device 16, such as when activation device 16 is misaligned with respect to array 12 or when beam 28 has a pattern or size that does not encompass the entirety of array 12, each of unactivated devices 14a will not be positioned to reflect light to sensor 38.

Controller 48 may be connected to sensor 38 and may include software or code so as to determine when light is received at sensor 38 from individual ones of device 14. Accordingly, sensor 38 may indicate to controller 48 of system 10 that light is not detected at one or more of sensors 38 from one or more of sensing devices 14. The light detection, or lack of light detection, information received by controller 48 from sensor 38 may then be utilized to move activation device 16, or to change the size or pattern of beam 28, so that beam 28 is correctly aligned and patterned with respect to array 12. In other words, if activation device 16 is misaligned or incorrectly patterned or sized with respect to array 12, some of sensing devices 14 may not be activated and therefore may not reflect light to sensor 38. Controller 48 may utilize its software or code to deduce this information and correct the position and/or size/pattern of light source 40 and/or activation device 16 such that the entirety of array 12 is illuminated by light source 40 and/or is within the activation path of activation device 16, including each corner 46 and all of edge regions 44 of array 12. Accordingly, one or more sensing devices 14 may be utilized to align and/or size/pattern light source 40 and/or activation device 16 with respect to array 12 by reflecting light from sensing devices 14 to sensor 38 and by use of that information by controller 48. The alignment and/or size/pattern correction of light source 40 and/or beam 28 of activation device 16 may occur on an ongoing or continuous feedback basis during use of display 10 such that a full and focused image on imaging region 20 is actively maintained.

FIG. 2 is a schematic top view of one embodiment of a display system 10 including several micromirror arrays 12 and several activation devices 16. In this embodiment, two arrays 12a and 12b and two activation devices 16a and 16b are positioned within housing 18. Each of arrays 12a and 12b may include a plurality of imaging micromirrors 24 and a plurality of sensing micromirrors 14 placed in edge region 44 of arrays 12a and 12b, respectively. In operation, activation device 16a may activate each of sensing devices 14 on array 12a and activation device 16b may activate each of sensing devices 14 on array 12b. Light source 40 may then project light to arrays 12a and 12b to illuminate the entirety of each of arrays 12a and 12b. Each of sensing devices 14 on array 12a or 12b, respectively, that are activated by activation device 16a or 16b, respectively, will then reflect light to a corresponding sensor 38a or 38b. Controller 48 may then utilize software or code to determine, based on light information received at sensors 38a and 38b, if light source 40 is properly aligned with arrays 12a and/or 12b, and/or if activation devices 16a and 16b are properly aligned and/or sized or patterned with respect to arrays 12a and 12b, respectively. In particular, controller 48 may utilize software or code to determine if light source 40 produces a light beam 42 that defines a cone of light 56 that illuminates an array 12. For example, as shown in FIG. 2, cone of light 56a is shown illuminating the entirety of array 12a. However, cone of light 56b is shown not illuminating an entirety of array 12b such that a position of array 12b or of light source 40 would be changed by controller 48, or motors controlled by controller 48, to ensure that cone of light 56b illuminates an entirety of array 12b.

Similarly, if controller 48 determines that activation devices 16a or 16b are not properly aligned and/or electron beam 28 is not properly sized/patterned with respect to corresponding array 12, controller 48 may move and/or change the size or pattern of electron beam 28 of activation device 16a and/or 16b with respect to its corresponding array 12. In particular, controller 48 may utilize software or code to determine if activation device 16 produces an activation beam 28 that defines a pattern 58 that activates an array 12. For example, as shown in FIG. 2, pattern 58a is shown activating the entirety of array 12a. However, pattern 58b is shown not activating an entirety of array 12b such that a position of array 12b or of activation device 16b would be changed by controller 48, or motors controlled by controller 48, to ensure that pattern 58b activates an entirety of array 12b. Accordingly, sensing devices 14 on array 12 may be utilized to correct any type of distortion of activation beam 28, such as skew, bow, keystone, pin cushion, linearity, centering or size of the activation beam 28.

Light information detected at sensor 38 may also be utilized by controller 48 to determine if arrays 12a and 12b, or more, such as arrays 12c (not shown), etc., are aligned with respect to one another, and/or if activation devices 16a and 16b, or more, such as 16c, etc. (not shown), are aligned with respect to one another. For example, controller 48 may use light information from sensors 38a and/or 38b to determine if an axis 60a of array 12a is positioned parallel to an axis 60b of array 12b. If not, controller 48 may position one or more of arrays 12 to align the axes 60 of each array in a parallel manner. In the embodiment shown, axis 60 may be a vertical axis of array 12. However, controller 48 may be utilized to align the axes of plural arrays 12, wherein the axis 60 may be a rotational axis, a horizontal axis, or any other type of alignment axis or plane about which an array may be aligned. Additionally, controller 48 may use light information from sensors 38a and/or 38b to determine if an axis 62a of activation device 16a is positioned parallel to an axis 62b of activation device 16b. If not, controller 48 may position one or more of activation devices 16 to align the axes 62 of each activation device in a parallel manner.

Sensing mirrors 14 may be fabricated on array 12 along with imaging mirrors 24 without substantially increasing the process costs of manufacturing array 12. The sensing mirrors 14 may be utilized to align multiple arrays 12 with respect to one another. The sensing mirrors 14 may also be utilized to align one or more arrays 12 with respect to one or more light sources 40. Sensing mirrors 14 may also be utilized to align and/or size and/or pattern an electron beam from one or more electron beam generation devices with respect to one or more arrays and with respect to another beam generation device.

Still referring to FIG. 2, in another embodiment sensing devices 14 may be electrical sensors 14 that may be connected directly to controller 48 via a wire 54 such that when electron beam 28 is swept over electrical sensors 14, the sensors may indicate via wire 54 directly to controller 48 that the sensors have been activated. In this manner, controller 48 may utilize its software or code to determine and then adjust the position and/or size/pattern of electron beam 28.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

We claim:

1. A display system, comprising:
an array that defines multiple reflective devices, a first subset of said devices each movable into a position to reflect light to an imaging region and a second subset of said devices each positioned to reflect light to a sensing region; and
a light source that projects a light beam to said array, wherein light reflected by said first subset is incident on said imaging region and wherein light reflected by said second subset is incident on said sensing region.

2. The system of claim 1 wherein said light source projects light having a first wavelength to said first subset of said devices and projects light having a second wavelength to said second subset of said devices.

3. The system of claim 1 further comprising:
a sensor positioned in said sensing region and adapted to receive light reflected by said second subset of said devices;
an activation device that projects an activation beam to said devices to move individual ones of said devices between an active position and an inactive position; and
a controller coupled to said sensor and to said activation device, said controller controlling a position of said activation device based on sensing information received from said sensor positioned in said sensing region.

4. The system of claim 1 wherein said devices comprise micromirrors.

5. The system of claim 3 wherein said sensor is chosen from one of a photo diode and a photo transmitter.

6. The system of claim 3 wherein said activation device is an electron beam generator.

7. The system of claim 1 wherein said second subset of said devices includes an individual device positioned at each of four corners of a micromirror array.

8. The system of claim 1 wherein said second subset of said devices includes a plurality of devices positioned in an edge region of a micromirror array.

9. The system of claim 1 wherein each one of said first subset of said devices moves between said position to reflect light to said imaging region and a second position to reflect light to a light dump and wherein said light dump, said imaging region and said sensing region each define a location different from one another.

10. The system of claim 1 wherein each one of said second subset of said devices is movable into a position to reflect light to said sensing region.

11. The system of claim 1 wherein said array defines a plane, and wherein a front reflective surface of each of said first subset of said devices positioned in said position to reflect light to an imaging region is positioned at an angle in a range of −90 to +90 degrees with respect to said plane, and wherein a front reflective surface of each of said second subset of said devices positioned in said position to reflect light to a sensing region is positioned at an angle in a range of −90 to +90 degrees with respect to said plane.

12. A method of operating an optical system, comprising:
projecting an activation beam of an activation beam generator to a micromirror array to move sensing mirrors of said micromirror array from a non-sensing position to a sensing position;
projecting light to said sensing mirrors such that said light is reflected from said sensing mirrors in said sensing position to an alignment sensor; and
aligning a position of said activation beam generator with respect to said micromirror array based on light received by said alignment sensor.

13. The method of claim 12 wherein said micromirror array is a MEMs device.

14. The method of claim 12 further comprising projecting light to imaging mirrors of said micromirror array such that light is reflected from said imaging mirrors to an imaging region.

15. The method of claim 14 wherein said light projected to said sensing mirrors is of a first wavelength and said light projected to said imaging mirrors is of a second wavelength different from said first wavelength.

16. The method of claim 12 further comprising:
projecting said activation beam of said activation beam generator to a second micromirror array to move sensing mirrors of said second micromirror array from a non-sensing position to a sensing position;
projecting light to said sensing mirrors of said second array such that light is reflected from said sensing mirrors in said sensing position of said second array to said alignment sensor; and
aligning a position of said second micromirror array with respect to said micromirror array based on light received by said alignment sensor.

17. The method of claim 12 further comprising:
projecting a second activation beam of a second activation beam generator to said micromirror array to move said sensing mirrors from a non-sensing position to a sensing position;
projecting light to said sensing mirrors of said array such that said light is reflected from said sensing mirrors in said sensing position of said array to said alignment sensor; and
aligning a position of said second activation beam generator with respect to said activation beam generator based on light received by said alignment sensor.

18. An optical display, comprising:
means for reflecting light including means for reflecting light to an imaging region and means for reflecting light to a sensing region;
means for projecting light to said means for reflecting light; and
means for moving said means for reflecting light to an imaging region, wherein a position of said means for moving, with respect to said means for reflecting light, is aligned based on light reflected to said sensing region by said means for reflecting light to a sensing region.

19. The display of claim 18 wherein said means for reflecting light to a sensing region is movably positioned by said means for moving.

20. The display of claim 18 wherein said means for reflecting light to an imaging region comprises a first plurality of micromirrors mounted on a substrate that defines a plane, said means for reflecting light to a sensing region comprises a second plurality of micromirrors mounted on said substrate, wherein said first plurality of micromirrors are inclined at a first angle with respect to said plane when reflecting light to said imaging region and wherein said second plurality of micromirrors are inclined at a second angle with respect to said plane when reflecting light to said sensing region.

21. The display of claim 18 wherein said means for moving comprises an electron beam generator.

22. An optical display apparatus, comprising:
a first plurality of reflective devices movable between an active position to reflect light to an imaging region and an inactive position to reflect light away from said imaging region;
a second plurality of reflective devices positioned to reflect light to a sensor; and
an activation structure that operates to move said first plurality of reflective devices between said active and inactive positions, wherein a position of said activation structure with respect to said first plurality of reflective devices is controlled in response to light received by said sensor.

23. The apparatus of claim 22 wherein each of said second plurality of reflective devices is movable between said position to reflect light to said sensor and another position to reflect light away from said sensor.

24. The apparatus of claim 23 wherein said activation structure operates to move said second plurality of reflective devices between said position to reflect light to said sensor and said another position to reflect light away from said sensor.

25. The apparatus of claim 22 further including a housing that defines a vacuum enclosure, wherein said activation structure, and said first and second plurality of reflective devices are positioned within said vacuum enclosure.

26. A display system, comprising:
a first micromirror array including movable imaging micromirrors and sensing micromirrors;
a second micromirror array including movable imaging micromirrors and sensing micromirrors; and
an activation device operable to move the imaging micromirrors of said first and second micromirror arrays,
wherein said first and second micromirror arrays are aligned with respect to each other based on light reflected from said sensing micromirrors on said first and second micromirror arrays.

27. The system of claim 26 further comprising a third micromirror array including movable imaging micromirrors and sensing micromirrors, wherein said first, second and third micromirror arrays are aligned with respect to each other based on light reflected from said sensing micromirrors on said first, second and third micromirror arrays

28. An optical display system, comprising:
a plurality of reflective devices movable between an active position to reflect light to an imaging region and an inactive position to reflect light away from said imaging region;
a plurality of sensing devices interspersed with said plurality of reflective devices and each adapted to indicate to a controller when said sensing device is activated;
an activation structure that produces an activation beam that moves individual ones of said plurality of reflective devices between said active and inactive positions when said beam is directed thereto, and that activates individual ones of said sensing devices when said beam is directed thereto; and
a controller that adjusts a position of said activation structure with respect to said plurality of reflective devices in response to activation of individual ones of said sensing devices.

29. The system of claim 28 wherein said controller adjusts a size of said activation beam in response to activation of individual ones of said sensing devices.

30. The system of claim 28 wherein said controller adjusts a pattern of said activation beam in response to activation of individual ones of said sensing devices.

31. The system of claim 28 wherein said plurality of reflective devices define first and second modulators, and wherein said controller adjusts a position of each of said first and second modulators with respect to one another in response to activation of individual ones of said sensing devices.

32. The system of claim 28 wherein said activation structure defines first and second activation beam generators, and wherein said controller adjusts a position of each of said first and second activation beam generators with respect to one another in response to activation of individual ones of said sensing devices.
